(19) United States
(12) Patent Application Publication
(10) Pub. No.: US 2007/0080483 A1
(43) Pub. Date: Apr. 12, 2007

(54) Process for producing injection molded product

(75) Inventors: Hirotaka Uosaki, Ichihara-shi (JP); Kuniaki Kawabe, Ichihara-shi (JP); Motoyasu Yasui, Chiba-shi (JP)

Correspondence Address: BUCHANAN, INGERSOLL & ROONEY PC, POST OFFICE BOX 1404, ALEXANDRIA, VA, 22313-1404, US

(73) Assignee: Mitsui Chemicals, Inc., Sodegaura-shi (JP)

(21) Appl. No.: 11/543,901

(22) Filed: Oct. 6, 2006

Related U.S. Application Data
(60) Provisional application No. 60/738,586, filed on Nov. 22, 2005.

(30) Foreign Application Priority Data
Oct. 7, 2005 (JP) 2005-295663

(51) Int. Cl. B29C 45/00; C08L 91/08; C08J 3/22; C08K 5/01

(52) U.S. Cl. 264/328.1; 524/487

(57) ABSTRACT

The present invention provides an injection molding process of a thermoplastic resin which is capable of thin molding or precision molding by improving injection moldability, particularly releasability or fluidity, without deteriorating the characteristics of the injection molded article of the thermoplastic resin. The process for producing an injection molded product comprises injection molding a mixture containing a thermoplastic resin and a polyolefin wax,

wherein the mixture has L/L₀≧1.05, the L being a flow length in the case where the mixture contains the polyolefin wax and the Lo being a flow length in the case where the mixture contains no polyolefin wax, the L and L₀ being measured under the conditions of a mold temperature of 40° C. and a resin temperature, Tr, as determined by the following equation:
Tr=¾×Tm+100 (wherein Tm represents a melting temperature (° C.) of the thermoplastic resin), using a spiral flow mold having a thickness of 1 mm and a width of 10 mm.

### BACKGROUND OF THE INVENTION

1. Field of the Invention

The present invention relates to a process for producing an injection molded product using a thermoplastic resin. More specifically, the present invention relates to a process for producing an injection molded product using a mixture containing a thermoplastic resin and a polyolefin wax.

2. Description of the Related Art

The thermoplastic resin is a resin having fluidity as a result of plasticization by means of heating, and is used to produce a variety of molded articles using various molding processes. However, if the thermoplastic resin is thin molded or precision molded by injection molding, problems that the molded article adheres to the mold, or the shape of the mold is not sufficiently expressed to the details may occur. For this reason, the releasability or the fluidity of the thermoplastic resin has greatly influenced the productivity of the injection molding of the thermoplastic resin, in particular, the production rate.

Generally, in the case of molding a resin, a plasticizer or a lubricant is used so as to improve releasability or fluidity. However, such the plasticizer or lubricant improves moldability, while it has a drawback that it lowers the characteristics, in particular, the mechanical strength or the heat resistance of the molded article. For this reason, there is suggested a thermoplastic resin composition to improve releasability or fluidity in the injection molding of the thermoplastic resin and to prevent the reduction of the characteristics of the molded article (refer to, for example, JP-A Nos. 5-209129, 9-111067, 2000-226478, and 2004-189864).

### SUMMARY OF THE INVENTION

The present invention is intended to solve the problems accompanied by the related art, and has an object to provide an injection molding process of a thermoplastic resin which is capable of thin molding or precision molding by improving injection moldability, particularly releasability or fluidity, without deteriorating the characteristics of the injection molded article of the thermoplastic resin.

The present inventors have earnestly studied to overcome the above-described problems, and as a result, they have found that a thermoplastic resin can be thin molded or precision molded by mixing a polyolefin wax with the thermoplastic resin to prepare a mixture comprising the thermoplastic resin and a polyolefin wax and having a longer flow length than the thermoplastic resin and excellent releasability, and by subjecting the mixture to injection molding. The finding leads to completion of the present invention.

Specifically, the process for producing an injection molded article according to the present invention comprises injection molding a mixture containing a thermoplastic resin and a polyolefin wax, wherein the mixture has L/L₀≧1.05, the L being a flow length in the case where the mixture contains the polyolefin wax and the L₀ being a flow length in the case where the mixture contains no polyolefin wax, the L and L₀ being measured under the conditions of a mold temperature of 40° C. and a resin temperature, Tr, as determined by the following equation:
Tr=¾×Tm+100
(wherein Tm represents a melting temperature (° C.) of the thermoplastic resin)using a spiral flow mold having a thickness of 1 mm and a width of 10 mm. In the above production process, the polyolefin wax is preferably contained in an amount of 0.5 to 15 parts by weight based on 100 parts by weight of the thermoplastic resin. The polyolefin wax is preferably a polyethylene wax, and the thermoplastic resin is preferably polypropylene or polyethylene.

According to the present invention, a thermoplastic resin is capable of thin molding or precision molding by adding a polyolefin wax to provide a longer flow length than the thermoplastic resin and improved releasability, without deteriorating the characteristics of the obtained molded article.

### DESCRIPTION OF THE PREFERRED EMBODIMENTS

The process for producing an injection molded article according to the present invention, is a process comprising

adding a polyolefin wax to a thermoplastic resin to prepar a mixture having L/L₀≧1.05, preferably 1.05≦L/L0≦1.30, and more preferably 1.05≦L/L0≦1.20, wherein the L is a flow length in the case where the mixture contains the polyolefin wax and the L₀ is a flow length in the case where the mixture contains no polyolefin wax, and wherein the L and L₀ are measured under the conditions of a mold temperature of 40° C. and a resin temperature, Tr, as determined by the following equation:
Tr=¾×Tm+100
(wherein Tm represents a melting temperature (° C.) of the thermoplastic resin, particularly crystal melting point (° C.) for a crystalline resin) using a spiral flow mold having a thickness of 1 mm and a width of 10 mm; and

injection molding the mixture.

The mixture having the L/L₀ within the above range is excellent in fluidity, and when subjecting the mixture to injection molding, the resin does not leak into the spaces between the mold, and is sufficiently filled even in every corner of the mold to fully reproduce the shape of the mold. Accordingly, the mixture can be preferably used in the thin film molding or precision molding.

Hereinbelow, the thermoplastic resin and the polyolefin wax, which are used in the production process of the present invention will be described.

[Thermoplastic Resin]

Examples of the thermoplastic resin used in the present invention include polyolefins such as low-density polyethylenes such as linear low-density polyethylene, medium-density polyethylenes, high density polyethylenes, polypropylene, and an ethylene-propylene copolymer; olefin-vinyl compound copolymers such as an ethylene-acrylic acid copolymer, an ethylene-methacrylic acid copolymer or an esterification product thereof, an ethylene-vinyl acetate copolymer, and an ethylene-vinyl alcohol copolymer; polyester resins such as polyvinyl chloride, polystyrene, and polyethylene terephthalate; and polyamide resins. Further, a graft copolymer, a block copolymer, or a random copolymer thereof can be used. In addition, these resins can be used in combination of two or more kinds.

The MI (190° C.) of the high density polyethylene is preferably in the range of 3.0 to 20 g/10 min., and more preferably in the range of 4.0 to 15 g/10 min. With the MI of the high density polyethylene in the above range, a molded product which is excellent in texture, rigidity, impact strength, chemical resistance and the like can be obtained.

Further, the density of the high density polyethylene is preferably in the range of 942 to 970 kg/m³, more preferably in the range of 950 to 965 kg/m³. With the density of the high density polyethylene in the above range, a molded product which is excellent in texture, rigidity, impact strength, chemical resistance, and the like can be obtained.

The MI (230° C.) of the polypropylene is preferably in the range of 3.0 to 60 g/10 min., and more preferably in the range of 5.0 to 55 g/10 min. With the MI of the polyethylene in the above range, a molded product which is excellent in heat resistance, rigidity, and the like can be obtained.

[Polyolefin Wax]

The polyolefin wax used in the present invention is an olefin oligomer including a homopolymer or copolymer of α-olefins, and can be prepared using a Ziegler catalyst or a metallocene catalyst. Among these, a polyethylene wax such as a homopolymer of ethylene or a copolymer of ethylene and an α-olefin having 3 to 20 carbon atoms is preferable, and a polyethylene wax (hereinafter, simply referred to as a “metallocene polyethylene wax”) prepared by using a metallocene catalyst is particularly preferable.

In the copolymer of ethylene and an α-olefin having 3 to 20 carbon atoms, the α-olefin preferably has 3 to 10 carbon atoms, and the α-olefin is more preferably propylene having 3 carbon atoms, 1-butene having 4 carbon atoms, 1-pentene having 5 carbon atoms, 1-hexene and 4-methyl-1-pentene having 6 carbon atoms, 1-octene having 8 carbon atoms, or the like, and particularly preferably propylene, 1-butene, 1-hexene, or 4-methyl-1-pentene.

The polyolefin wax has a number-average molecular weight (Mn) in terms of polyethylene, as measured by gel permeation chromatography, in the range of usually 400 to 5,000, preferably 1,000 to 4,000, more preferably 1,500 to 4,000. With the Mn of the polyolefin wax in the above range, there are provided such the effects as increased improvement on the fluidity, longer flow length, thus making the precision molding easier, as well as exhibition of good releasing effect, thus excellent mold releasability and prevention of mold fouling.

Further, the ratio (Mw/Mn) of the weight-average molecular weight (Mw) to the number-average molecular weight (Mn) in terms of polyethylene, as measured by gel permeation chromatography, is in the range of usually 1.2 to 4.0, preferably 1.5 to 3.5, more preferably 1.5 to 3.0. With the Mw/Mn in the above range, mold releasability is excellent, and mold fouling can be prevented.

The melting point, as measured by differential scanning calorimetry (DSC), is in the range of usually 65 to 130° C., preferably 70 to 130° C., more preferably 75 to 130° C. With the melting point in the above range, mold releasability is excellent, and mold fouling can be prevented.

The density, as measured by a density gradient tube process, is in the range of usually 850 to 980 kg/m³, preferably 870 to 980 kg/m³, more preferably 890 to 980 kg/m³. With the density in the above range, mold releasability is excellent, and mold fouling can be prevented.

Further, the polyolefin wax preferably satisfies the following relationship represented by the following formula (I), preferably the following formula (Ia), and more preferably the following formula (Ib), of the crystallization temperature (Tc (° C.), measured at a temperature lowering rate of 2° C./min.), as measured by a differential scanning calorimetry (DSC), and the density (D (kg/m³)), as measured by a density gradient tube process:
0.501×D−366≧Tc (I)
0.501×D−366.5≧Tc (Ia)
0.501×D−367≧Tc (Ib)

When the crystallization temperature (Tc) and the density (D) of the polyolefin wax satisfies the above formula, the composition of the comonomers of the polyolefin wax is uniform, and as a result, the content of the tacky components of the thermoplastic resin, particularly the polyolefin is decreased, and thus the tackiness of the mixture or the composition comprising the thermoplastic resin and the polyolefin wax tends to be reduced.

It is preferable that the penetration hardness is usually 30 dmm or less, preferably 25 dmm or less, more preferably 20 dmm or less, even more preferably 15 dmm or less. The penetration hardness is a value measured in accordance with JIS K2207. With the penetration hardness in the above range, a molded article having sufficient rigidity can be obtained.

The acetone extraction quantity is in the range of preferably 0 to 20% by weight, more preferably 0 to 15% by weight. With the acetone extraction quantity in the above range, mold releasability is excellent, and mold fouling can be prevented. The acetone extraction quantity is a value measured in the following manner. 200 ml of acetone is introduced into a round-bottom flask (300 ml) in the lower part of a Soxhlet's extractor (made of glass) through a filter(ADVANCE, No. 84). Extraction is carried out in a hot-water bath at 70° C. for 5 hours. 10 g of the first wax is set on the filter.

The polyolefin wax is a solid at room temperature, and is a low-viscosity liquid at 65 to 130° C.

The polyolefin wax is preferably prepared using a catalyst for olefin polymerization comprising, for example,

(A) a metallocene compound of a transition metal selected from Group 4 of the periodic table, and

(B) at least one kind of the compound selected from (b-1) an organoaluminum oxy-compound, (b-2) a compound which reacts with the metallocene compound (A) to form ion pairs, and (b-3) an organoaluminum compound. Particularly, in the case of preparing a polyolefin wax having a low Mw/Mn, the metallocene catalyst is effective.

(A) Metallocene Compound of Transition Metal Selected from Group 4 of Periodic Table:

The metallocene compound for forming the metallocene catalyst is a metallocene compound of a transition metal selected from Group 4 of the periodic table, and a specific example thereof is a compound represented by the following formula (1):
M¹Lₓ (1)

In the above formula, M¹ is a transition metal selected from Group 4 of the periodic table, x is a valence of the transition metal M¹, and L is a ligand. Examples of the transition metals indicated by M¹ include zirconium, titanium and hafnium. L is a ligand coordinated to the transition metal M¹, and at least one ligand L is a ligand having cyclopentadienyl skeleton. This ligand having cyclopentadienyl skeleton may have a substituent. Examples of the ligands L having cyclopentadienyl skeleton include a cyclopentadienyl group, alkyl or cycloalkyl substituted cyclopentadienyl groups, such as methylcyclopentadienyl, ethylcyclopentadienyl, n- or i-propylcyclopentadienyl, n-, i-, sec-, or t-butylcyclopentadienyl, dimethylcyclopentadienyl, methylpropylcyclopentadienyl, methylbutylcyclopentadienyl and methylbenzylcyclopentadienyl, an indenyl group, a 4,5,6,7-tetrahydroindenyl group and a fluorenyl group. In these ligands having cyclopentadienyl skeleton, hydrogen may be replaced with a halogen atom, a trialkylsilyl group or the like.

When the metallocene compound has two or more ligands having cyclopentadienyl skeleton as ligands L, two of the ligands having cyclopentadienyl skeleton may be bonded to each other through an alkylene group, such as ethylene or propylene, a substituted alkylene group, such as isopropylidene or diphenylmethylene, a silylene group, or a substituted silylene group, such as dimethylsilylene, diphenylsilylene or methylphenylsilylene.

The ligand L other than the ligand having cyclopentadienyl skeleton (ligand having no cyclopentadienyl skeleton) is, for example, a hydrocarbon group of 1 to 12 carbon atoms, an alkoxy group, an aryloxy group, a sulfonic acid-containing group (—SO₃R¹), wherein R¹ is an alkyl group, an alkyl group substituted with a halogen atom, an aryl group, an aryl group substituted with a halogen atom, or an aryl group substituted with an alkyl group, a halogen atom or a hydrogen atom.

(Example 1 of Metallocene Compound)

When the metallocene compound represented by the above formula (1) has a transition metal valence of, for example, 4, this metallocene compound is more specifically represented by the following formula (2):
R²ₖR³₁R⁴ₘR⁵ₙM¹ (2)

wherein M¹ is a transition metal selected from Group 4 of the periodic table, R² is a group (ligand) having cyclopentadienyl skeleton, and R³, R⁴ and R⁵ are each independently a group (ligand) having or not having cyclopentadienyl skeleton, k is an integer of 1 or greater, and k+1+m+n=4.

Examples of the metallocene compounds having zirconium as M¹ and having at least two ligands having cyclopentadienyl skeleton include bis(cyclopentadienyl)zirconium monochloride monohydride, bis(cyclopentadienyl)zirconium dichloride, bis(1-methyl-3-butylcyclopentadienyl)zirconium-bis(trifluoromethanesulfonate) and bis(1,3-dimethylcyclopentadienyl)zirconium dichloride.

Also employable are compounds wherein the 1,3-position substituted cyclopentadienyl group in the above compounds is replaced with a 1,2-position substituted cyclopentadienyl group. As another example of the metallocene compound, a metallocene compound of bridge type wherein at least two of R², R³, R⁴ and R⁵ in the formula (2), e.g., R² and R³, are groups (ligands) having cyclopentadienyl skeleton and these at least two groups are bonded to each other through an alkylene group, a substituted alkylene group, a silylene group, a substituted silylene group or the like is also employable. In this case, R⁴ and R⁵ are each independently the same as the aforesaid ligand L other than the ligand having cyclopentadienyl skeleton.

Examples of the metallocene compounds of bridge type include ethylenebis(indenyl)dimethylzirconium, ethylenebis(indenyl)zirconium dichloride, isopropylidene(cyclopentadienyl-fluorenyl)zirconium dichloride, diphenylsilylenebis(indenyl)zirconium dichloride and methylphenylsilylenebis(indenyl)zirconium dichloride.

(Example 2 of Metallocene Compound)

Another example of the metallocene compound is a metallocene compound represented by the following formula (3) that is described in JP-A No. 268307/1992.

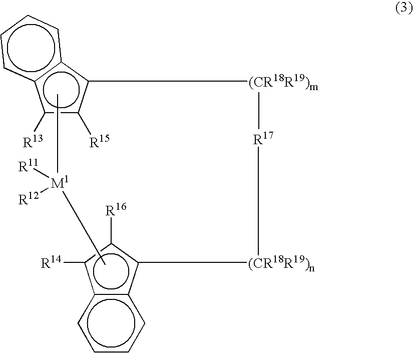

In the above formula, M¹ is a transition metal of Group 4 of the periodic table, specifically titanium, zirconium or hafnium.

R₁₁ and R¹² may be the same as or different from each other and are each a hydrogen atom, an alkyl group of 1 to 10 carbon atoms, an alkoxy group of 1 to 10 carbon atoms, an aryl group of 6 to 10 carbon atoms, an aryloxy group of 6 to 10 carbon atoms, an alkenyl group of 2 to 10 carbon atoms, an arylalkyl group of 7 to 40 carbon atoms, an alkylaryl group of 7 to 40 carbon atoms, an arylalkenyl group of 8 to 40 carbon atoms or a halogen atom. R¹¹ and R¹² are each preferably a chlorine atom.

R¹³ and R¹⁴ may be the same as or different from each other and are each a hydrogen atom, a halogen atom, an alkyl group of 1 to 10 carbon atoms which may be halogenated, an aryl group of 6 to 10 carbon atoms, or a group of —N(R²⁰)₂, —SR²⁰, —OSi (R²⁰)₃, —Si (R²⁰)₃or —P(R²⁰ )₂. R²⁰ is a halogen atom, preferably a chlorine atom, an alkyl group of 1 to 10 carbon atoms (preferably 1 to 3 carbon atoms) or an aryl group of 6 to 10 carbon atoms (preferably 6 to 8 carbon atoms). R¹³ and R¹⁴ are each particularly preferably a hydrogen atom.

R¹⁵ and R¹⁶ are the same as R¹³ and R¹⁴, except that a hydrogen atom is not included, and they may be the same as or different from each other, preferably the same as each other. R¹⁵ and R¹⁶ are each preferably an alkyl group of 1 to 4 carbon atoms which may be halogenated, specifically methyl, ethyl, propyl, isopropyl, butyl, isobutyl, trifluoromethyl or the like, particularly preferably methyl. In the formula (3), R¹⁷ is selected from the following group. 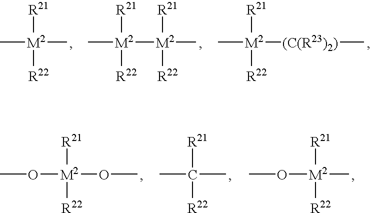
═BR²¹, ═AlR²¹, —Ge—, —Sn—, —O—, —S—, ═SO, ═SO₂, ═NR²¹, ═CO, ═PR²¹, ═P(O)R²¹, etc.

M² is silicon, germanium or tin, preferably silicon or germanium. R²¹, R²² and R²³ may be the same as or different from one another and are each a hydrogen atom, a halogen atom, an alkyl group of 1 to 10 carbon atoms, a fluoroalkyl group of 1 to 10 carbon atoms, an aryl group of 6 to 10 carbon atom, a fluoroaryl group of 6 to 10 carbon atoms, an alkoxy group of 1 to 10 carbon atoms, an alkenyl group of 2 to 10 carbon atoms, an arylalkyl group of 7 to 40 carbon atoms, an arylalkenyl group of 8 to 40 carbon atoms, or an alkylaryl group of 7 to 40 carbon atoms. R²¹ and R²² or R²¹ and R²³ may form a ring together with atoms to which they are bonded. R¹⁷ is preferably ═CR²¹R²², ═SiR²¹R²², ═GeR²¹R²², —O—, —S—, ═SO, ═PR²¹ or ═P(O)R²¹. R¹⁸ and R¹⁹ may be the same as or different from each other and are each the same atom or group as that of R²¹. m and n may be the same as or different from each other and are each 0, 1 or 2, preferably 0 or 1, and m+n is 0, 1 or 2, preferably 0 or 1.

Examples of the metallocene compounds represented by the formula (3) include rac-ethylene(2-methyl-1-indenyl)₂-zirconium dichloride and rac-dimethylsilylene (2-methyl-1-indenyl)₂-zirconium dichloride. These metallocene compounds can be prepared by, for example, a process described in JP-A No. 268307.

Example 3 of Metallocene Compound

As the metallocene compound, a metallocene compound represented by the following formula (4) is also employable.

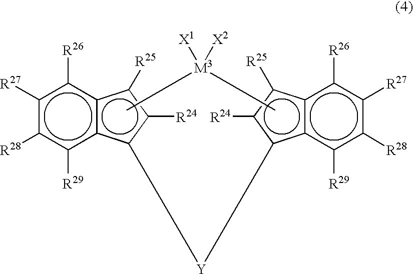

In the formula (4), M³ is a transition metal atom of Group 4 of the periodic table, specifically titanium, zirconium or hafnium. R²⁴ and R²⁵ may be the same as or different from each other and are each a hydrogen atom, a halogen atom, a hydrocarbon group of 1 to 20 carbon atoms, a halogenated hydrocarbon group of 1 to 20 carbon atoms, a silicon-containing group, an oxygen-containing group, a sulfur-containing group, a nitrogen-containing group or a phosphorus-containing group. R²⁴ is preferably a hydrocarbon group, particularly preferably an alkyl group of 1 to 3 carbon atoms, i.e., methyl, ethyl or propyl. R²⁵ is preferably a hydrogen atom or hydrocarbon group, particularly preferably a hydrogen atom or an alkyl group of 1 to 3 carbon atoms, i.e., methyl, ethyl or propyl. R²⁶, R²⁷, R²⁸ and R²⁹ may be the same as or different from one another and are each a hydrogen atom, a halogen atom, a hydrocarbon group of 1 to 20 carbon atoms or a halogenated hydrocarbon group of 1 to 20 carbon atoms. Of these, preferable is a hydrogen atom, a hydrocarbon group or a halogenated hydrocarbon group. At least one combination of “R²⁶ and R²⁷” and “R²⁷ and R²⁸”, and “R²⁸ and R²⁹” may form a monocyclic aromatic ring together with carbon atoms to which they are bonded. When there are two or more hydrocarbon groups or halogenated hydrocarbon groups other than the groups that form the aromatic ring, they may be bonded to each other to form a ring. When R²⁹ is a substituent other than the aromatic group, it is preferably a hydrogen atom. X¹ and X² may be the same as or different from each other and are each a hydrogen atom, a halogen atom, a hydrocarbon group of 1 to 20 carbon atoms, a halogenated hydrocarbon group of 1 to 20 carbon atoms, an oxygen-containing group or a sulfur-containing group. Y is a divalent hydrocarbon group of 1 to 20 carbon atoms, a divalent halogenated hydrocarbon group of 1 to 20 carbon atoms, a divalent silicon-containing group, a divalent germanium-containing group, a divalent tin-containing group, —O—, —CO—, —S—, —SO—, —SO₂—, —NR³⁰—, —P (R³⁰)—, —P (O) (R³⁰)—, —BR³⁰— or —AlR³⁰— (R³⁰ is a hydrogen atom, a halogen atom, a hydrocarbon group of 1 to 20 carbon atoms or a halogenated hydrocarbon group of 1 to 20 carbon atoms).

Examples of the ligands in the formula (4) which have a monocyclic aromatic ring formed by mutual bonding of at least one combination of “R²⁶ and R²⁷”, “R²⁷ and R²⁸”, and “R²⁸ and R²⁹” and which are coordinated to M³ include those represented by the following formulas:

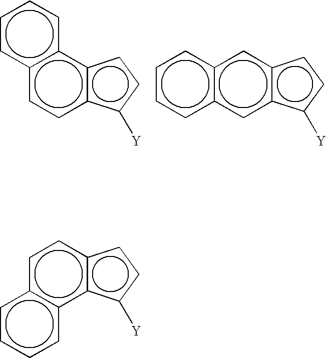

(wherein Y is the same as that described in the above-mentioned formula).

Example 4 of Metallocene Compound

As the metallocene compound, a metallocene compound represented by the following formula (5) is also employable.

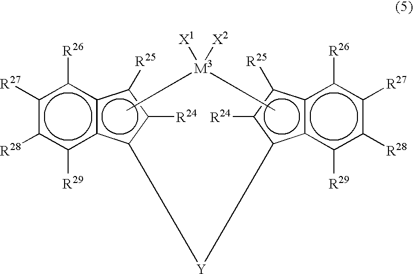

In the formula (5), M³, R²⁴, R²⁵, R²⁶, R²⁷, R²⁸ and R²⁹ are the same as those in the formula (4). Of R²⁶, R²⁷, R²⁸ and R²⁹, two groups including R²⁶ are each preferably an alkyl group, and R²⁶ and R²⁸, or R²⁸ and R²⁹ are each preferably an alkyl group. This alkyl group is preferably a secondary or tertiary alkyl group. Further, this alkyl group may be substituted with a halogen atom or a silicon-containing group. Examples of the halogen atoms and the silicon-containing groups include substituents exemplified with respect to R²⁴ and R²⁵. Of R²⁶, R²⁷, R²⁸ and R²⁹, groups other than the alkyl group are each preferably a hydrogen atom. Two groups selected from R²⁶, R²⁷, R²⁸ and R²⁹ may be bonded to each other to form a monocycle or a polycycle other than the aromatic ring. Examples of the halogen atoms include the same atoms as described with respect to R²⁴ and R²⁵. Examples of X¹, X² and Y include the same atoms and groups as previously described.

Examples of the metallocene compounds represented by the formula (5) include:

rac-dimethylsilylene-bis(4,7-dimethyl-1-indenyl)zirconium dichloride, rac-dimethylsilylene-bis(2,4,7-trimethyl-1-indenyl)zirconium dichloride and rac-dimethylsilylene-bis(2,4,6-trimethyl-1-indenyl)zirconium dichloride.

Also employable are transition metal compounds wherein the zirconium metal is replaced with a titanium metal or a hafnium metal in the above compounds. The transition metal compound is usually used as a racemic modification, but R form or S form is also employable.

Example 5 of Metallocene Compound

As the metallocene compound, a metallocene compound represented by the following formula (6) is also employable.

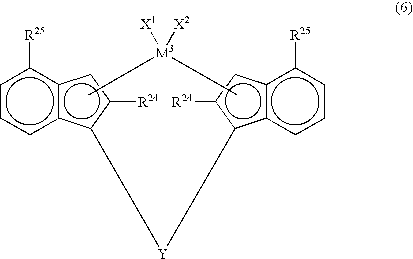

In the formula (6), M³, R²⁴, X¹, X² and Y are the same as those in the formula (4). R²⁴ is preferably a hydrocarbon group, particularly preferably an alkyl group of 1 to 4 carbon atoms, i.e., methyl, ethyl, propyl or butyl. R²⁵ is an aryl group of 6 to 16 carbon atoms. R²⁵ is preferably phenyl or naphthyl. The aryl group may be substituted with a halogen atom, a hydrocarbon group of 1 to 20 carbon atoms or a halogenated hydrocarbon group of 1 to 20 carbon atom. X¹ and X² are each preferably a halogen atom or a hydrocarbon group of 1 to 20 carbon atoms.

Examples of the metallocene compounds represented by the formula (6) include:

rac-dimethylsilylene-bis(4-phenyl-1-indenyl)zirconium dichloride, rac-dimethylsilylene-bis(2-methyl-4-phenyl-1-indenyl)zirconium dichloride, rac-dimethylsilylene-bis(2-methyl-4-(α-naphthyl)-1-indenyl)zirconium dichloride, rac-dimethylsilylene-bis(2-methyl-4-(β-naphthyl)-1-indenyl)zirconium dichloride and rac-dimethylsilylene-bis(2-methyl-4-(1-anthryl)-1-indenyl)zirconium dichloride. Also employable are transition metal compounds wherein the zirconium metal is replaced with a titanium metal or a hafnium metal in the above compounds.

(Example 6 of Metallocene Compound)

As the metallocene compound, a metallocene compound represented by the following formula (7) is also employable.
LaM⁴X³₂ (7)

In the above formula, M⁴ is a metal of Group 4 or lanthanide series of the periodic table. La is a derivative of a delocalized π bond group and is a group imparting a constraint geometric shape to the metal M⁴ active site. Each X³ may be the same or different and is a hydrogen atom, a halogen atom, a hydrocarbon group of 20 or less carbon atoms, a silyl group having 20 or less silicon atoms or a germyl group having 20 or less germanium atoms.

Of such compounds, a compound represented by the following formula (8) is preferable.

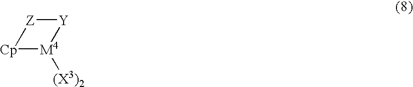

In the formula (8), M⁴ is titanium, zirconium or hafnium. X³ is the same as that described in the formula (7). Cp is π-bonded to M⁴ and is a substituted cyclopentadienyl group having a substituent Z. Z is oxygen, sulfur, boron or an element of Group 4 of the periodic table (e.g., silicon, germanium or tin). Y is a ligand having nitrogen, phosphorus, oxygen or sulfur, and Z and Y may together form a condensed ring. Examples of the metallocene compounds represented by the formula (8) include:

(dimethyl(t-butylamide)(tetramethyl-η⁵-cyclopentadienyl)silane)titanium dichloride and ((t-butylamide)(tetramethyl-η⁵-cyclopentadienyl)-1,2-ethanediyl)titanium dichloride. Also employable are metallocene compounds wherein titanium is replaced with zirconium or hafnium in the above compounds.

(Example 7 of Metallocene Compound)

As the metallocene compound, a metallocene compound represented by the following formula (9) is also employable.

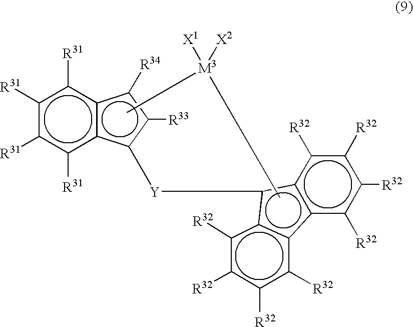

In the formula (9), M³ is a transition metal atom of Group 4 of the periodic table, specifically titanium, zirconium or hafnium, preferably zirconium. Each R³¹ may be the same or different, and at least one of them is an aryl group of 11 to 20 carbon atoms, an arylalkyl group of 12 to 40 carbon atoms, an arylalkenyl group of 13 to 40 carbon atoms, an alkylaryl group of 12 to 40 carbon atoms or a silicon-containing group, or at least two neighboring groups of the groups indicated by R³¹ form single or plural aromatic rings or aliphatic rings together with carbon atoms to which they are bonded. In this case, the ring formed by R³¹ has 4 to 20 carbon atoms in all including carbon atoms to which R³¹ is bonded. R³¹ other than R³¹ that is an aryl group, an arylalkyl group, an arylalkenyl group or an alkylaryl group or that forms an aromatic ring or an aliphatic ring is a hydrogen atom, a halogen atom, an alkyl group of 1 to 10 carbon atoms or a silicon-containing group. Each R³² may be the same or different and is a hydrogen atom, a halogen atom, an alkyl group of 1 to 10 carbon atoms, an aryl group of 6 to 20 carbon atoms, an alkenyl group of 2 to 10 carbon atoms, an arylalkyl group of 7 to 40 carbon atoms, an arylalkenyl group of 8 to 40 carbon atoms, an alkylaryl group of 7 to 40 carbon atoms, a silicon-containing group, an oxygen-containing group, a sulfur-containing group, a nitrogen-containing group or a phosphorus-containing group. At least two neighboring groups of the groups indicated by R³² may form single or plural aromatic rings or aliphatic rings together with carbon atoms to which they are bonded. In this case, the ring formed by R³² has 4 to 20 carbon atoms in all including carbon atoms to which R³² is bonded. R³² other than R³² that forms an aromatic ring or an aliphatic ring is a hydrogen atom, a halogen atom, an alkyl group of 1 to 10 carbon atoms or a silicon-containing group. In the groups constituted of single or plural aromatic rings or aliphatic rings formed by two groups indicated by R³², an embodiment wherein the fluorenyl group part has such a structure as represented by the following formula is included.

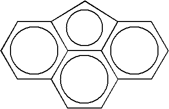

R³² is preferably a hydrogen atom or an alkyl group, particularly preferably a hydrogen atom or a hydrocarbon group of 1 to 3 carbon atoms, i.e., methyl, ethyl or propyl. A preferred example of the fluorenyl group having R³² as such a substituent is a 2,7-dialkyl-fluorenyl group, and in this case, an alkyl group of the 2,7-dialkyl is, for example, an alkyl group of 1 to 5 carbon atoms. R³¹ and R³² may be the same as or different from each other. R³³ and R³⁴ may be the same as or different from each other and are each a hydrogen atom, a halogen atom, an alkyl group of 1 to 10 carbon atoms, an aryl group of 6 to 20 carbon atoms, an alkenyl group of 2 to 10 carbon atoms, an arylalkyl group of 7 to 40 carbon atoms, and arylalkenyl group of 8 to 40 carbon atoms, an alkylaryl group of 7 to 40 carbon atoms, a silicon-containing group, an oxygen-containing group, a sulfur-containing group, a nitrogen-containing group or a phosphorus-containing group, similarly to the above. At least one of R³³ and R³⁴ is preferably an alkyl group of 1 to 3 carbon atoms. X¹ and X² may be the same as or different from each other and are each a hydrogen atom, a halogen atom, a hydrocarbon group of 1 to 20 carbon atoms, a halogenated hydrocarbon group of 1 to 20 carbon atoms, an oxygen-containing group, a sulfur-containing group or a nitrogen-containing group, or X¹ and X² form a conjugated diene residue. Preferred examples of the conjugated diene residues formed from X¹ and X² include residues of 1,3-butadiene, 2,4-hexadiene, 1-phenyl-1,3-pentadiene and 1,4-diphenylbutadiene, and these residues may be further substituted with a hydrocarbon group of 1 to 10 carbon atoms. X¹ and X² are each preferably a halogen atom, a hydrocarbon group of 1 to 20 carbon atoms or a sulfur-containing group. Y is a divalent hydrocarbon group of 1 to 20 carbon atoms, a divalent halogenated hydrocarbon group of 1 to 20 carbon atoms, a divalent silicon-containing group, a divalent germanium-containing group, a divalent tin-containing group, —O—, —CO—, —S—, —SO—, —SO₂—, —NR³⁵—, —P(R³⁵)—, —P(O)(R³⁵)—, —BR³⁵— or —AlR³⁵— (R³⁵ is a hydrogen atom, a halogen atom, a hydrocarbon group of 1 to 20 carbon atoms or a halogenated hydrocarbon group of 1 to 20 carbon atoms). Of these divalent groups, preferable are those wherein the shortest linkage part of —Y— is constituted of one or two atoms. R³⁵ is a halogen atom, a hydrocarbon group of 1 to 20 carbon atoms or a halogenated hydrocarbon group of 1 to 20 carbon atoms. Y is preferably a divalent hydrocarbon group of 1 to 5 carbon atoms, a divalent silicon-containing group or a divalent germanium-containing group, more preferably a divalent silicon-containing group, particularly preferably alkylsilylene, alkylarylsilylene or arylsilylene.

(Example 8 of Metallocene Compound)

As the metallocene compound, a metallocene compound represented by the following formula (10) is also employable.

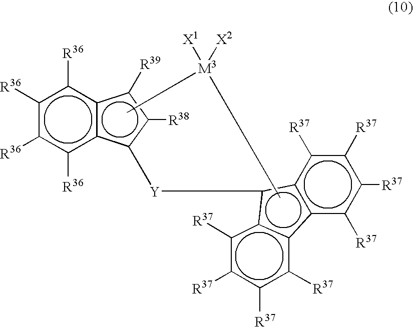

In the formula (10), M³ is a transition metal atom of Group 4 of the periodic table, specifically titanium, zirconium or hafnium, preferably zirconium. Each R³⁶ may be the same or different and is a hydrogen atom, a halogen atom, an alkyl group of 1 to 10 carbon atoms, an aryl group of 6 to 10 carbon atoms, an alkenyl group of 2 to 10 carbon atoms, a silicon-containing group, an oxygen-containing group, a sulfur-containing group, a nitrogen-containing group or a phosphorus-containing group. The alkyl group and the alkenyl group may be substituted with a halogen atom. R³⁶ is preferably an alkyl group, an aryl group or a hydrogen atom, particularly preferably a hydrocarbon group of 1 to 3 carbon atoms, i.e., methyl, ethyl, n-propyl or i-propyl, an aryl group, such as phenyl, α-naphthyl or β-naphthyl, or a hydrogen atom. Each R³⁷ may be the same or different and is a hydrogen atom, a halogen atom, an alkyl group of 1 to 10 carbon atoms, an aryl group of 6 to 20 carbon atoms, an alkenyl group of 2 to 10 carbon atoms, an arylalkyl group of 7 to 40 carbon atoms, an arylalkenyl group of 8 to 40 carbon atoms, an alkylaryl group of 7 to 40 carbon atoms, a silicon-containing group, an oxygen-containing group, a sulfur-containing group, a nitrogen-containing group or a phosphorus-containing group. The alkyl group, the aryl group, the alkenyl group, the arylalkyl group, the arylalkenyl group and the alkylaryl group may be substituted with halogen. R³⁷ is preferably a hydrogen atom or an alkyl group, particularly preferably a hydrogen atom or a hydrocarbon group of 1 to 4 carbon atoms, i.e., methyl, ethyl, n-propyl, i-propyl, n-butyl or tert-butyl. R³⁶ and R³⁷ may be the same as or different from each other. One of R³⁸ and R³⁹ is an alkyl group of 1 to 5 carbon atoms, and the other is a hydrogen atom, a halogen atom, an alkyl group of 1 to 10 carbon atoms, an alkenyl group of 2 to 10 carbon atoms, a silicon-containing group, an oxygen-containing group, a sulfur-containing group, a nitrogen-containing group or a phosphorus-containing group. It is preferable that one of R³⁸ and R³⁹ is an alkyl group of 1 to 3 carbon atoms, such as methyl, ethyl or propyl, and the other is a hydrogen atom. X¹ and X² may be the same as or different from each other and are each a hydrogen atom, a halogen atom, a hydrocarbon group of 1 to 20 carbon atoms, a halogenated hydrocarbon group of 1 to 20 carbon atoms, an oxygen-containing group, a sulfur-containing group or a nitrogen-containing group, or X¹ and X² form a conjugated diene residue. X¹ and X² are each preferably a halogen atom or a hydrocarbon group of 1 to 20 carbon atoms. Y is a divalent hydrocarbon group of 1 to 20 carbon atoms, a divalent halogenated hydrocarbon group of 1 to 20 carbon atoms, a divalent silicon-containing group, a divalent germanium-containing group, a divalent tin-containing group, —O—, —CO—, —S—, —SO—, —SO₂—, —NR⁴⁰—, —P(R⁴⁰)—, —P(O) (R⁴⁰)—, —BR⁴⁰— or —AlR⁴⁰— (R⁴⁰ is a hydrogen atom, a halogen atom, a hydrocarbon group of 1 to 20 carbon atoms or a halogenated hydrocarbon group of 1 to 20 carbon atoms). Y is preferably a divalent hydrocarbon group of 1 to 5 carbon atoms, a divalent silicon-containing group or a divalent germanium-containing group, more preferably a divalent silicon-containing group, particularly preferably alkylsilylene, alkylarylsilylene or arylsilylene.

(Example 9 of Metallocene Compound)

As the metallocene compound, a metallocene compound represented by the following formula (11) is also employable.

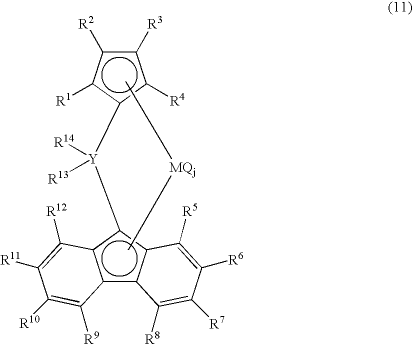

In the formula (11), Y is selected from carbon, silicon, germanium and tin atoms, M is Ti, Zr or Hf, R¹, R², R³, R⁴, R⁵, R⁶, R⁷, R⁸, R⁹, R¹⁰, R¹¹ and R¹² may be the same as or different from each other, and selected from hydrogen, a hydrocarbon group, and a silicon containing group, the adjacent substituents of R⁵ to R¹² may be bonded to each other to form a ring, R¹³ and R¹⁴ may be the same as or different from each other, and selected from a hydrocarbon group, and a silicon containing group, and R¹³ and R¹⁴ may be bonded to each other to form a ring. Q may be selected in the same or different combination from halogen, a hydrocarbon group, an anionic ligand, and a neutral ligand which can be coordinated to a lone pair of electrons, and j is an integer of 1 to 4. Hereinbelow, the cyclopentadienyl group, the fluorenyl group, and the bridged part which are the characteristics in the chemical structure of the metallocene compound used in the present invention, and other characteristics are sequentially explained, and then preferred metallocene compounds having both these characteristics are also explained.

(Cyclopentadienyl Group)

The cyclopentadienyl group may be substituted or unsubstituted. The phrase “substituted or unsubstituted cyclopentadienyl group” means a cyclopentadienyl group in which R¹, R², R³, and R⁴ of the cyclopentadienyl skeleton in the formula (11) are all hydrogen atoms, or at least one of R¹, R², R³, and R⁴ is a hydrocarbon group (f1), preferably a hydrocarbon group (f1′) having a total of 1 to 20 carbon atoms, or a silicon-containing group (f2), preferably a silicon-containing group (f2′) having a total of 1 to 20 carbon atoms. If at least two of R¹, R², R³, and R⁴ are substituted, the substituents may be the same as or different from each other. Further, the phrase “hydrocarbon group having a total of 1 to 20 carbon atoms” means an alkyl group, an alkenyl group, an alkynyl group, or an aryl group, which is composed of only carbon and hydrogen. It includes one in which both of any two adjacent hydrogen atoms are substituted to form an alicyclic or aromatic ring.

Examples of the hydrocarbon group (f1′) having a total of 1 to 20 carbon atoms includes, in addition to an alkyl group, an alkenyl group, an alkynyl group, or an aryl group, which is composed of only carbon and hydrogen, a heteroatom-containing hydrocarbon group which is a hydrocarbon group in which a part of the hydrogen atoms directly bonded to carbon atoms are substituted with a halogen atom, an oxygen-containing group, a nitrogen-containing group, or a silicon-containing group, and an alicyclic group in which any two hydrogen atoms which are adjacent to each other are substituted. Examples of the hydrocarbon group (f1′) include:

a linear hydrocarbon group such as a methyl group, an ethyl group, an n-propyl group, an allyl group, an n-butyl group, an n-pentyl group, an n-hexyl group, an n-heptyl group, an n-octyl group, an n-nonyl group, and an n-decanyl group;

a branched hydrocarbon group such as an isopropyl group, a t-butyl group, an amyl group, a 3-methylpentyl group, a 1,1-diethylpropyl group, a 1,1-dimethylbutyl group, a 1-methyl-1-propyl butyl group, a 1,1-propyl butyl group, a 1,1-dimethyl-2-methylpropyl group, and a 1-methyl-1-isopropyl-2-methylpropyl group;

a cycloalkane group such as a cyclopentyl group, a cyclohexyl group, a cycloheptyl group, a cyclooctyl group, a norbornyl group, and an adamanthyl group;

a cyclic, unsaturated hydrocarbon group and a nuclear alkyl-substituted product thereof such as a phenyl group, a naphthyl group, a biphenyl group, a phenanthryl group, and an anthracenyl group;

a saturated hydrocarbons group substituted with an aryl group such as benzyl group and a cumyl group;

a heteroatom-containing hydrocarbon group such as a methoxy group, an ethoxy group, a phenoxy group, an N-methylamino group, a trifluoromethyl group, a tribromomethyl group, a pentafluoroethyl group, and a pentafluorophenyl group.

The phrase “silicon-containing group (f2)” means a group in which ring carbons of the cyclopentadienyl group are directly covalently bonded, and specific examples thereof include an alkyl silyl group and an aryl silyl group. Examples of the silicon-containing group (f2′) having a total of 1 to 20 carbon atoms include a trimethylsilyl group, and a triphenylsilyl group.

(Fluorenyl Group)

The fluorenyl group may be substituted or unsubstituted. The phrase “substituted or unsubstituted fluorenyl group” means a fluorenyl group in which R⁵, R⁶, R⁷, R⁸, R⁹, R¹⁰, R₁₁, and R¹² of the fluorenyl skeleton in the formula (11) are all hydrogen atoms, or at least one of R⁵, R⁶, R⁷, R⁸, R⁹, R¹⁰, R¹¹, and R¹² is a hydrocarbon group (f1), preferably a hydrocarbon group (f1′) having a total of 1 to 20 carbon atoms, or a silicon-containing group (f2), preferably a silicon-containing group (f2′) having a total of 1 to 20 carbon atoms. If at least two of R⁵, R⁶, R⁷, R⁸, R⁹, R¹⁰, R¹¹, and R¹² are substituted, the substituents may be the same as or different from each other. R⁵, R⁶, R⁷, R⁸, R⁹, R¹⁰, R¹¹, and R¹² may be bonded to each other to form a ring. From a viewpoint of easy preparation of a catalyst, R⁶ and R¹¹, and R⁷ and R¹⁰ are preferably the same to each other.

A preferable example of the hydrocarbon group (f1) is a hydrocarbon group (f1′) having a total of 1 to 20 carbon atoms, and a preferable example of the silicon-containing group (f2) is a silicon-containing group (f2′) having a total of 1 to 20 carbon atoms.

(Covalent Bond Bridging)

The main chain of the bond which binds the cyclopentadienyl group with the fluorenyl group is a divalent covalent bond bridging containing a carbon atom, a silicon atom, a germanium atom and a tin atom. An important point when carrying out a high temperature solution polymerization is that a bridging atom Y of the covalent bond bridging part has R¹³ and R¹⁴ which may be the same as or different from each other. A preferable example of the hydrocarbon group (f1) is a hydrocarbon group (f1′) having a total of 1 to 20 carbon atoms, and a preferable example of the silicon-containing group (f2) is a silicon-containing group (f2′) having a total of 1 to 20 carbon atoms.

(Other Characteristics of Metallocene Compound)

In the above-described formula (11), Q is selected in the same or different combination from halogen, a hydrocarbon group having 1 to 10 carbon atoms, a neutral, conjugated or non-conjugated diene having 10 carbon atoms or less, an anionic ligand, and a neutral ligand which can be coordinated to a lone pair of electrons. Specific examples of halogen include fluorine, chlorine, bromine, and iodine, and specific examples of the hydrocarbon group include methyl, ethyl, n-propyl, isopropyl, 2-methylpropyl, 1,1-dimethylpropyl, 2,2-dimethylpropyl, 1,1-diethylpropyl, 1-ethyl-1-methylpropyl, 1,1,2,2-tetramethylpropyl, sec-butyl, tert-butyl, 1,1-dimethylbutyl, 1,1,3-trimethylbutyl, neopentyl, cyclohexylmethyl, and cyclohexyl, 1-methyl-1-cyclohexyl. Specific examples of the neutral, conjugated or non-conjugated diene having 10 carbon atoms or less include s-cis- or s-trans-η⁴-1,3-butadiene, s-cis- or s-trans-η⁴-1,4-diphenyl-1,3-butadiene, s-cis- or s-trans-η⁴-3-methyl-1,3-pentadiene, s-cis- or s-trans-η⁴-1,4-dibenzyl-1,3-butadiene, s-cis- or s-trans-η⁴-2,4-hexadiene, s-cis- or s-trans-η4-1,3-pentadiene, s-cis- or s-trans-η⁴-1,4-ditolyl-1,3-butadiene, and s-cis- or s-trans-η⁴-1,4-bis(trimethylsilyl)-1,3-butadiene. Specific examples of the anionic ligand include an alkoxy group such as methoxy, tert-butoxy, and phenoxy, a carboxylate group such as acetate, and benzoate, and a sulfonate group such as mesylate, and tosylate. Specific examples of the neutral ligand which can be coordinated to a lone pair of electrons include organophosphorus compounds such as trimethylphosphine, triethylphosphine, triphenylphosphine, and diphenylmethyl phosphine, or ethers such as tetrahydrofuran, diethyl ether, dioxane, and 1,2-dimethoxyethane. j is an integer of 1 to 4, and when j is no less than 2, Q's may be the same as or different from each other.

(Example 10 of Metallocene Compound)

As the metallocene compound, a metallocene compound represented by the following formula (12) is also employable.

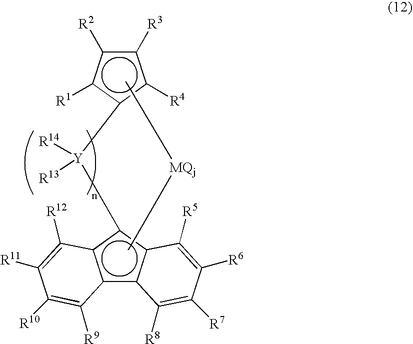

In the above formula, R¹, R², R³, R⁴, R⁵, R⁶, R⁷, R⁸, R⁹, R¹⁰, R¹¹, R¹², R¹³, and R¹⁴ may be the same as or different from each other, and selected from hydrogen, a hydrocarbon group, and a silicon containing group, the adjacent substituents of R¹ to R¹⁴ may be bonded to each other to form a ring, M is Ti, Zr or Hf, Y is an atom of Group 14 of the periodic table, Q is selected in the same or different combination from halogen, a hydrocarbon group, a neutral, conjugated or non-conjugated diene having 10 carbon atoms or less, an anionic ligand, and a neutral ligand which can be coordinated to a lone pair of electrons, n is an integer of 2 to 4, and j is an integer of 1 to 4.

In the formula (12), the hydrocarbon group is preferably an alkyl group having 1 to 20 carbon atoms, an aryl group having 7 to 20 carbon atoms, an aryl group having 6 to 20 carbon atoms, or an alkylaryl group having 7 to 20 carbon atoms, and may contain at least one ring structure. Specific examples thereof include methyl, ethyl, n-propyl, isopropyl, 2-methylpropyl, 1,1-dimethylpropyl, 2,2-dimethylpropyl, 1,1-diethylpropyl, 1-ethyl-1-methylpropyl, 1,1,2,2-tetramethylpropyl, sec-butyl, tert-butyl, 1,1-dimethylbutyl, 1,1,3-trimethyl butyl, neopentyl, cyclohexylmethyl, cyclohexyl, 1-methyl-1-cyclohexyl, 1-adamanthyl, 2-adamanthyl, 2-methyl-2-adamanthyl, menthyl, norbornyl, benzyl, 2-phenylethyl, 1-tetrahydro naphthyl, 1-methyl-1-tetrahydro naphthyl, phenyl, naphthyl, and tolyl.

In the formula (12), the silicon-containing group is preferably an alkyl or arylsilyl group having 1 to 4 silicon atoms and 3 to 20 carbon atoms, and specific examples thereof include trimethylsilyl, tert-butyldimethylsilyl, and triphenylsilyl.

In the present invention, R¹ to R¹⁴ in the formula (12) are selected from hydrogen, a hydrocarbon group, and a silicon-containing hydrocarbon group, and may be the same as or different from each other. Preferable examples of the hydrocarbon group and the silicon-containing group are as described above.

The adjacent substituents of R¹ to R¹⁴ in the cyclopentadienyl ring in the formula (12) may be bonded to each other to form a ring.

M of the formula (12) is an element of Group 4 of the periodic table, that is, zirconium, titanium or hafnium, preferably zirconium.

Y is an atom of Group 14 of the periodic table, preferably a carbon atom or a silicon atom. n is an integer of 2 to 4, preferably 2 to 3, and particularly preferably 2.

Q is selected in the same or different combination from halogen, a hydrocarbon group, a neutral, conjugated or non-conjugated diene having 10 carbon atoms or less, an anionic ligand, and a neutral ligand which can be coordinated to a lone pair of electrons. If Q is a hydrocarbon group, it is more preferably a hydrocarbon group having 1 to 10 carbon atoms.

Specific examples of halogen include fluorine, chlorine, bromine, and iodine, and specific examples of the hydrocarbon group include methyl, ethyl, n-propyl, isopropyl, 2-methylpropyl, 1,1-dimethylpropyl, 2,2-dimethylpropyl, 1,1-diethylpropyl, 1-ethyl-1-methylpropyl, 1,1,2,2-tetramethylpropyl, sec-butyl, tert-butyl, 1,1-dimethylbutyl, 1,1,3-trimethylbutyl, neopentyl, cyclohexylmethyl, and cyclohexyl, 1-methyl-1-cyclohexyl. Specific examples of the neutral, conjugated or non-conjugated diene having 10 carbon atoms or less include s-cis- or s-trans-η⁴-1,3-butadiene, s-cis- or s-trans-η⁴-1,4-diphenyl-1,3-butadiene, s-cis- or s-trans-η⁴-3-methyl-1,3-pentadiene, s-cis- or s-trans-η⁴-1,4-dibenzyl-1,3-butadiene, s-cis- or s-trans-η⁴-2,4-hexadiene, s-cis- or s-trans-η⁴-1,3-pentadiene, s-cis- or s-trans-η⁴-1,4-ditolyl-1,3-butadiene, and s-cis- or s-trans-η⁴-η⁴-1,4-bis(trimethylsilyl)-1,3-butadiene. Specific examples of the anionic ligand include an alkoxy group such as methoxy, tert-butoxy, and phenoxy, a carboxylate group such as acetate, and benzoate, and a sulfonate group such as mesylate, and tosylate. Specific examples of the neutral ligand which can be coordinated to a lone pair of electrons include organophosphorus compounds such as trimethylphosphine, triethylphosphine, triphenylphosphine, and diphenylmethyl phosphine, or ethers such as tetrahydrofuran, diethyl ether, dioxane, and 1,2-dimethoxyethane. When j is no less than 2, Q's may be the same as or different from each other.

In the formula (12), 2 to 4 Y's are present, and Y's may be the same as or different from each other. A plurality of R¹³'s and a plurality of R¹⁴'s may be the same as or different from each other. For example, a plurality of R¹³'s which are bonded to the same Y may be different from each other, and a plurality of R¹³'s which are bonded to the different Y's may be the same to each other. Otherwise, R¹³'s and R¹⁴'s may be taken to form a ring.

Preferable examples of the compound represented by the formula (12) include a transition metal compound represented by the following formula (13).

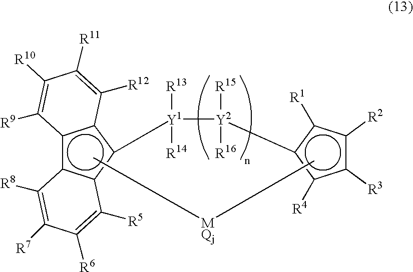

In the formula (13) , R¹, R², R³, R⁴, R⁵, R⁶, R⁷, R⁸, R⁹, R¹⁰, R¹¹, and R¹² may be the same as or different from each other, and selected from hydrogen, a hydrocarbon group, and a silicon containing group, R¹³, R¹⁴, R¹⁵, and R¹⁶ are hydrogen, or a hydrocarbon group, and n is an integer of 1 to 3. With n=1, R¹ to R¹⁶ are not hydrogen at the same time, and each may be the same as or different from each other. The adjacent substituents of R⁵ to R¹² may be bonded to each other to form a ring, R¹³ and R¹⁵ may be bonded to each other to form a ring, and R¹³ and R¹⁵, and R¹⁴ and R¹⁶ may be bonded to each other to form a ring at the same time, Y¹ and Y² are atoms of Group 14 of the periodic table, M is Ti, Zr or Hf, Q is selected in the same or different combination from halogen, a hydrocarbon group, an anionic ligand, and a neutral ligand which can be coordinated to a lone pair of electrons, and j is an integer of 1 to 4.

The compounds such as those as described in “Example 9 of Metallocene Compound” and “Example 10 of Metallocene Compound” are mentioned in JP-A No. 2004-175707, WO2001/027124, WO2004/029062, and WO2004/083265.

The metallocene compounds described above are used singly or in combination of two or more kinds. The metallocene compounds may be used after diluted with hydrocarbon, halogenated hydrocarbon or the like.

(b-1) Organoaluminum Oxy-Compound:

According to the present invention, as the organoaluminum oxy-compound (b-1), publicly known aluminoxane can be used as it is. Specifically, such publicly known aluminoxane is represented by the following formula (14) or (15).

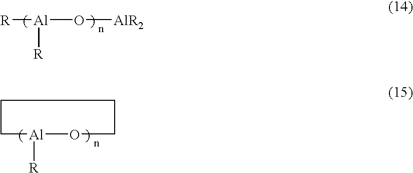

wherein R represents a hydrocarbon group having 1 to 10 carbon atoms, and n represents an integer of 2 or more. Among these compound, the methyl aluminoxanes in which R is a methyl group and n is 3 or more, preferably 10 or more are preferably used. These aluminoxanes may be incorporated with some organoaluminum compounds.

In addition, when a high temperature solution polymerization is carried out, the benzene-insoluble organoaluminum oxy-compounds as described in JP-A No. 2-78687 can be employed. Further, the organoaluminum oxy-compounds as described in JP-A No. 2-167305, and the aluminoxanes having at least two kinds of alkyl groups as described in JP-A Nos. 2-167305, 2-24701, and 3-103407 are preferably used. In addition, the phrase “benzene insoluble” regarding the organoaluminum oxy-compounds, the proportion of the Al components dissolved in benzene at 60° C. in terms of an Al atom is usually 10% or less, preferably 5% or less, and particularly preferably 2% or less, and that is, the compound has insolubility or poor solubility in benzene.

Examples of the organoaluminum oxy-compound (b-1) used in the present invention include a modified methyl aluminoxane having the structure of the following structure (16).

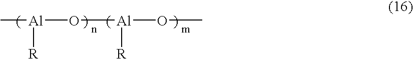

(wherein R represents a hydrocarbon group having 1 to 10 carbon atoms, and m and n represent integers of 2 or more). This modified methyl aluminoxane is prepared from trimethyl aluminum and alkyl aluminum other than trimethyl aluminum. This modified methyl aluminoxane is generally referred to as MMAO. Such the MMAO can prepared by the method as described in U.S. Pat. Nos. 4,960,878 and 5,041,584.

Further, the modified methyl aluminoxane in which R is an iso-butyl group, prepared from trimethyl aluminum and tri-isobutyl aluminum from Tosoh Finechem Corp., is commercially produced in a trade name of MMAO or TMAO.

The MMAO is aluminoxane with improved solubility in various solvents, and storage stability, and specifically, it is dissolved in an aliphatic or alicyclic hydrocarbon, although the aluminoxane described for the formula (14) or (15) has insolubility or poor solubility in benzene.

Further, examples of the organoaluminum oxy-compound (b-1) used in the present invention include a boron-containing organoaluminum oxy-compound represented by the following formula (17).

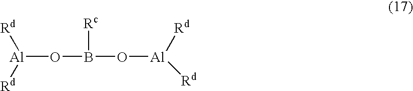

(wherein R^{c} represents a hydrocarbon group having 1 to 10 carbon atoms, R^{d}'s may be the same as or different from each other, and represent a hydrogen atom, a halogen atom or a hydrocarbon group having 1 to 10 carbon atoms).

(b-2) Compounds Which React with the Metallocene Compound (A) to Form an Ion Pair:

Examples of the compound (B-2) which reacts with the metallocene compound (A) to form an ion pair (referred to as an “ionic compound” hereinafter) may include Lewis acids, ionic compounds, borane compounds and carborane compounds, as described in each publication of JP-A Nos. 1-501950, 1-502036, 3-179005, 3-179006, 3-207703 and 3-207704, and U.S. Pat. No. 5,321,106. They also include a heteropoly compound and an iso-poly compound.

According to the present invention, the ionic compound which is preferably employed is a compound represented by the following formula (18).

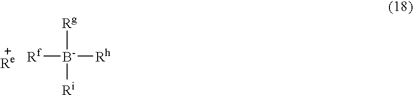

wherein examples of R^{e+} include H⁺, a carbenium cation, an oxonium cation, an ammonium cation, a phosphonium cation, a cycloheptyltrienyl cation, and a ferrocenium cation having transition metal. R^{f} to Rⁱ may be the same as or different from each other, and each represent an organic group, preferably an aryl group.

Specific examples of the carbenium cation include 3-substituted carbenium cations such as a triphenyl carbenium cation, a tris (methylphenyl) carbenium cation, and a tris (dimethylphenyl) carbenium cation.

Specific examples of the ammonium cation include a trialkyl ammonium cation such as a trimethyl ammonium cation, a triethyl ammonium cation, a tri (n-propyl) ammonium cation, a tri-isopropyl ammonium cation, a tri (n-butyl) ammonium cation, and a tri-isobutyl ammonium cation, a N,N-dialkyl anilinium cation such as an N,N-dimethyl anilinium cation, an N,N-diethyl anilinium cation, and an N,N-2,4,6-pentamethyl anilinium cation, and a dialkyl ammonium cation such as a diisopropyl ammonium cation and a dicyclohexyl ammonium cation.

Specific examples of the phosphonium cation include a triaryl phosphonium cation such as a triphenylphosphonium cation, tris (methylphenyl) phosphonium cation, and tris (dimethylphenyl) phosphonium cation.

Among them, R^{e+} is preferably a carbenium cation, an ammonium cation, or the like, and particularly preferably a triphenylcarbenium cation, a N,N-dimethyl anilinium cation, or an N,N-diethyl anilinium cation.

Specific examples of the carbenium salts include triphenyl carbenium tetraphenylborate, triphenyl carbenium tetrakis(pentafluorophenyl)borate, triphenyl carbenium tetrakis (3,5-ditrifluoromethylphenyl) borate, tris (4-methylphenyl) carbenium tetrakis(pentafluorophenyl)borate, and tris(3,5-dimethylphenyl) carbenium tetrakis(pentafluorophenyl)borate.

Examples of the ammonium salt include a trialkyl-substituted ammonium salt, an N,N-dialkyl anilinium salt, and a dialkyl ammonium salt.

Examples of the trialkyl-substituted ammonium salt include triethyl ammonium tetraphenyl borate, tripropyl ammonium tetraphenyl borate, tri(n-butyl)ammonium tetraphenyl borate, trimethyl ammonium tetrakis(p-tolyl)borate, trimethyl ammonium tetrakis(o-tolyl)borate, tri(n-butyl)ammonium tetrakis(pentafluorophenyl)borate, triethyl ammonium tetrakis(pentafluorophenyl)borate, tripropyl ammonium tetrakis(pentafluorophenyl)borate, tripropyl ammonium tetrakis(2,4-dimethylphenyl)borate, tri(n-butyl)ammonium tetrakis(3,5-dimethylphenyl)borate, tri(n-butyl)ammonium tetrakis(4-trifluoromethylphenyl)borate, tri(n-butyl)ammonium tetrakis(3,5-ditrifluoromethylphenyl)borate, tri(n-butyl)ammonium tetrakis(o-tolyl)borate, dioctadecyl methyl ammonium tetraphenyl borate, dioctadecyl methyl ammonium tetrakis(p-tolyl)borate, dioctadecyl methyl ammonium tetrakis(o-tolyl)borate, dioctadecyl methyl ammonium tetrakis(pentafluorophenyl)borate, dioctadecyl methyl ammonium tetrakis(2,4-dimethylphenyl)borate, dioctadecyl methyl ammonium tetrakis(3,5-dimethylphenyl)borate, dioctadecyl methyl ammonium tetrakis(4-trifluoromethylphenyl)borate, dioctadecyl methyl ammonium tetrakis(3,5-ditrifluoromethylphenyl)borate, and dioctadecyl methyl ammonium.

Examples of the N,N-dialkyl anilinium salt, include N,N-dimethyl anilinium tetraphenyl borate, N,N-dimethyl anilinium tetrakis(pentafluorophenyl)borate, N,N-dimethyl anilinium tetrakis(3,5-ditrifluoromethylphenyl)borate, N,N-diethyl anilinium tetraphenyl borate, N,N-diethyl anilinium tetrakis(pentafluorophenyl)borate, N,N-diethyl anilinium tetrakis(3,5-ditrifluoromethylphenyl)borate, N,N-2,4,6-pentamethyl anilinium tetraphenyl borate, and N,N-2,4,6-pentamethyl anilinium tetrakis(pentafluorophenyl)borate.

Examples of the dialkyl ammonium salt include di(1-propyl)ammonium tetrakis(pentafluorophenyl)borate, and dicyclohexyl ammonium tetraphenyl borate.

The ionic compounds as disclosed in JP-A No. 2004-51676 by the present Applicant can be used without any restriction. The ionic compounds (b-2) can be used in a mixture of two or more kinds.

(b-3) Organoaluminum Compound:

Examples of the organoaluminum compound (b-3) which constitutes the catalyst for olefin polymerization include an organoaluminum compound represented by the following formula (19), and an alkylated complex with a metal element from Group 1 of the periodic table and aluminum, which is represented by the following formula (20):
R^{a}ₘAl(OR^{b})ₙHₚX_{q} (19)

(wherein R^{a} and R^{b} are may be the same as or different from each other and each represent a hydrocarbon group having usually 1 to 15 carbon atoms, preferably 1 to 4 carbon atoms, X is a halogen atom, and m, n, p, and q are numbers satisfying the conditions: 0<m≦3, 0≦n<3, 0≦p<3, and 0≦q<3, while m+n+p+q=3).
M²AlR^{a}₄ (20)

(wherein M² is Li, Na or K, and R^{a} is a hydrocarbon group having usually 1 to 15 carbon atoms, preferably 1 to 4 carbon atoms). Specific examples of the compound represented by the formula (19) include tri-n-alkyl aluminum such as trimethyl aluminum, triethyl aluminum, tri-n-butyl aluminum, trihexyl aluminum, and trioctyl aluminum; tri-branch chained alkyl aluminum such as tri-isopropyl aluminum, tri-isobutyl aluminum, tri-sec-butyl aluminum, tri-tert-butyl aluminum, tri-2-methylbutyl aluminum, tri-3-methyl hexyl aluminum, and tri-2-ethylhexyl aluminum; tri-cycloalkyl aluminum such as tri-cyclohexyl aluminum, and tri-cyclooctyl aluminum; triaryl aluminum such as triphenyl aluminum, and tritolyl aluminum; dialkyl aluminum hydride such as diisopropyl aluminum hydride, and diisobutyl aluminum hydride; alkenyl aluminum, such as isoprenyl aluminum, represented by the formula: (i-C₄H₉)ₓAl_{y}(C₅H₁₀)_{z} (wherein x, y and z are positive integers, and z is the numbers satisfying the conditions: z≦2x); alkyl aluminum alkoxide such as isobutyl aluminum methoxide, and isobutyl aluminum ethoxide; dialkyl aluminum alkoxide such as dimethyl aluminum methoxide, diethyl aluminum ethoxide, and dibutyl aluminum butoxide; alkyl aluminum sesquialkoxide such as ethyl aluminum sesquiethoxide, and butyl aluminum sesquibutoxide; partially alkoxylated alkyl aluminum, for example, having a mean compositions represented by the general formula R^{a}_{2.5}Al (OR^{b})_{0.5}; alkyl aluminum aryloxy such as diethyl aluminum phenoxide, diethyl aluminum (2,6-di-t-butyl-4-methylphenoxide); dialkyl aluminum halide such as dimethyl aluminum chloride, diethyl aluminum chloride, dibutyl aluminum chloride, diethyl aluminum bromide, and diisobutyl aluminum chloride; alkyl aluminum sesquihalide such as ethyl aluminum sesquichloride, butyl aluminum sesquichloride, and ethyl aluminum sesquibromide; partially halogenated alkyl aluminum of alkyl aluminum dihalide such as ethyl aluminum dichloride; dialkyl aluminum hydride such as diethyl aluminum hydride, and dibutyl aluminum hydride; other partially hydrogenated alkyl aluminum, for example, alkyl aluminum dihydrides such as ethyl aluminum dihydride and propyl aluminum dihydride; and partially alkoxylated and halogenated alkyl aluminums such as ethyl aluminum ethoxychloride, butyl aluminum butoxychloride and ethyl aluminum ethoxybromide.

Specific examples of the compounds represented by the formula (20) include LiAl (C₂H₅)₄ and LiAl (C₇H₁₅)₄. The compounds similar to the compounds represented by the formula (20), for example, the organoaluminum compounds in which two or more aluminum compounds are bonded via a nitrogen atom, can be used. Specific examples thereof include (C₂H₅)₂AlN (C₂H₅) Al (C₂H₅)₂.

From a viewpoint of easy availability, as an organoaluminum compound (b-3), trimethyl aluminum or tri-isobutyl aluminum is preferably used.

(Polymerization)

The polyethylene wax used in the invention is obtained by homopolymerizing ethylene usually in a liquid phase or homopolymerizing or copolymerizing ethylene and an α-olefin usually in a liquid phase, in the presence of the above-mentioned metallocene catalyst. In the polymerization, the method for using each of the components, and the sequence of addition are optionally selected, but the following methods may be mentioned.

[q1] A method for adding a component (A) alone to a polymerization reactor.

[q2] A method for adding a component (A) and a component (B) to a polymerization reactor in any order.

For the [q2] method, at least two of each catalyst components may be in contact with each other beforehand. At this time, a hydrocarbon solvent is generally used, but an α-olefin may be used as a solvent. In addition, the monomers used herein are as previously described.

As the polymerization process, suspension polymerization wherein polymerization is carried out in such a state that the polyethylene wax is present as particles in a solvent such as hexane, or gas phase polymerization wherein a solvent is not used, or solution polymerization wherein polymerization is carried out at a polymerization temperature of not lower than 140° C. in such a state that the polyethylene wax is molten in the presence of a solvent or is molten alone is employable. Among these, solution polymerization is preferable in both aspects of economy and quality.

The polymerization reaction may be carried out as any of a batch process and a continuous process. When the polymerization is carried out as a batch process, the afore-mentioned catalyst components are used in the concentrations described below.

The component (A) in the polymerization of an olefin using the above-described catalyst for polymerization of an olefin is used in the amount in the range of usually 10⁻⁹ to 10⁻¹ mmol/liter, preferably 10⁻⁸ to 10⁻² mmol/liter.

The component (b-1) is used in the amount in the range of usually 0.01 to 5,000, preferably 0.05 to 2,000, as a mole ratio of all transition metal atoms (M) in the component (b-1) to the component (A) [(b-1)/M]. The component (b-2) is used in the amount in the range of usually 0.5 to 5,000, preferably 1 to 2,000, as a mole ratio of the ionic compounds in the components (b-2) to all transition metals (M) in the component of (A) [(b-2)/M]. The component (b-3) is used in the amount in the range of usually 1 to 10000, preferably 1 to 5000, as a mole ratio of the component (b-3) to the transition metal atoms (M) in the component (A) [(b-3)/M].

The polymerization reaction is carried out under the conditions of a temperature of usually −20 to +200° C., preferably 50 to 180° C., more preferably 70 to 180° C., and a pressure of more than 0 and not more than 7.8 MPa (80 kgf/cm², gauge pressure), preferably more than 0 and not more than 4.9 MPa (50 kgf/cm², gauge pressure).

In the presence of the metallocene catalyst, ethylene and/or an α-olefin are fed, followed by polymerization. At this time, further, a molecular weight modifier such as hydrogen can be added. When polymerization is carried out in this manner, a polymer produced is usually obtained as a polymerization solution containing the polymer. Therefore, by treating the polymerization solution in the usual way, a polyethylene wax is obtained.

As the metallocene catalyst, a catalyst containing the metallocene compound described in “Example 6 of metallocene compound” is preferable.

<Mixture of Thermoplastic Resin and Polyolefin Wax>

The thermoplastic resin and the polyolefin wax may be previously mixed (pre-mixed) prior to feeding them to an injection molding machine, and a polyolefin wax may be fed to the resin fed (for example, side-fed) to injection molding machine, followed by mixing them. In either of the cases, in the injection, a mixture containing the thermoplastic resin and the polyolefin wax is formed. The premix method is not particularly limited, but a dry blending or a melt blending is adopted. Further, according to the intended purposes, various additives such as an antioxidant, an ultraviolet absorber, a light stabilizer, a colorant, a metallic soap, a plasticizer, a foaming agent, a filler, an anti-aging agent, a flame retardant, an antibacterial agent, or the like can be mixed with the mixture.

In order to obtain a mixture containing the thermoplastic resin and the polyolefin wax and having an L/L₀ in the above range, it is preferable that the polyolefin wax is contained in the proportion of usually 0.5 to 15 part by weight, preferably 1 to 10 parts by weight, and more preferably 2 to 7 parts by weight, based on 100 parts by weight of the thermoplastic resin.

The mixture containing the thermoplastic resin and the polyolefin wax, which is obtained by pre-mixing or side-feeding as described above, is injection-molded in a desired shape.

The injection molding can be carried out under a per se known condition. Specifically, the molding temperature is determined by the following equation:
Tr=¾×Tm+100

wherein Tm represents a melting temperature (° C.) of the thermoplastic resin, particularly crystal melting point (° C.) for a crystalline resin. The molding temperature is in the range of usually 180 to 400° C., preferably 200 to 300° C., more preferably 200 to 250° C., and the injection pressure is in the range of usually 10 to 200 MPa, preferably 20 to 150 MPa. Further, the mold temperature is in the range of usually 20 to 200° C., preferably 20 to 80° C., and more preferably 20 to 60° C.

### EXAMPLES

The present invention is further described with reference to the following examples, but it should be construed that the invention is in no way limited to those examples.

### Comparative Example 1

The flow length of a propylene block/copolymer (product name: Prime Polypro J704WA, manufactured by Prime Polymer Co., Ltd., crystal melting temperature: 160° C.) was determined under the following conditions.

(Measurement of Flow Length)

Injection molding was carried out using a mold for measurement of a resin flow length (thickness 1 mm×width 10 mm) under the conditions of a resin temperature of 220° C. and a mold temperature of 40° C. with an injection molding machine (manufactured by Toshiba Machine Co., Ltd., 55 ton injection molding machine (IS55EPNi1.5B)) to measure a flow length (spiral flow length).

Next, for the propylene block/copolymer, injection molding was carried out under the following conditions to prepare a molded article, and various physical properties thereof were evaluated. The results thereof are shown in Table 1.

[Condition for Injection Molding]

Injection molding machine: manufactured by Toshiba Machine Co., Ltd., 55 ton injection molding machine (IS55EPNi1.5B),

Molding temperature: 220° C.

Injection pressure: 105 MPa,

Mold temperature: 40° C.

Cooling time of mold: 20 seconds.

[Evaluation of Physical Properties]

(Releasability)

By means of the injection molding machine, under the above-described conditions (except for the cooling time of the mold), a plane (100 mm×100 mm×3 mm in thick) was made by injection molding, and then cooled at a cooling time of 10 seconds. Thereafter, the molded article in the mold was pushed out with a pin, upon which the releasability was evaluated based on the following criteria.

o: The molded article is demolded without resistance, but is not deformed.

x: The molded article is deformed with large release resistance due to adherence to a mold, or the like.

(Flow Mark)

A plane (100 mm×100 mm×3 mm in thick) was made by injection molding using the injection molding machine under the above-described conditions, and then flow mark was observed.

o: The flow mark is not observed.

x: The flow mark is observed.

(Tensile Yield Stress)

A test specimen was prepared using the injection molding machine under the above-described conditions, and a tensile yield stress thereof was measured in accordance with JIS K7161.

(Flexural Elastic Modulus, and Flexural Strength)

A test specimen was prepared using the injection molding machine under the above-described conditions, and a flexural elastic modulus and a flexural strength thereof were measured in accordance with JIS K7171.

(Heat Resistance)

A test specimen was prepared using the injection molding machine under the above-described conditions, and a Vicat softening point thereof was measured in accordance with JIS K7206.

(Impact Resistance)

A test specimen was prepared using an injection molding machine under the above conditions, and an Izod impact strength thereof was measured in accordance with JIS K7110.

### Examples 1 and 2

To 100 parts by weight of Propylene block copolymer (product name: Prime Polypro J704WA, manufactured by Prime Polymer Co., Ltd., crystal melting temperature: 160° C.), 1 part by weight or 3 parts by weight of a metallocene polyethylene wax (Excerex (Registered Trademark) 30200BT, manufactured by Mitsui Chemical Inc., content of ethylene: 95 mol %, density: 913 kg/m³, average molecular weights (Mn)=2000 and (Mw)=5000, and crystallization temperature (Tc)=86 ° C.) prepared by using a metallocene catalyst was added, and then sufficiently mixed in a tumbler mixer to prepare a mixture of the polypropylene and the polyethylene wax. The flow length of this mixture was measured in the same manner as in Comparative Example 1. Further, this mixture was subjected to injection molding in the same manner as in Comparative Example 1, and various physical properties thereof were evaluated. The results are shown in Table 1.

TABLE 1

| | | Comp. Ex. 1 | Ex. 1 | Ex. 2 |
|---|---|---|---|---|
| Metallocene PE wax (parts by weight) | | 0 | 1 | 3 |
| Flow length (cm) | | 67 | 71 | 72 |
| L/L₀ | | 1 | 1.05 | 1.06 |
| Releasability | | X | ◯ | ◯ |
| Flow mark | | ◯ | ◯ | ◯ |
| Tensile yield stress (MPa) | | 32 | 31 | 30 |
| Flexural elastic modulus (MPa) | | 1400 | 1400 | 1380 |
| Flexural Strength (MPa) | | 44 | 44 | 43 |
| Vicat softening point (° C.) | | 153 | 153 | 153 |
| Izod impact strength | −30° C. | 38 | 37 | 36 |
| (J/m) | 23° C. | 95 | 98 | 96 |

In comparison of Examples 1 and 2 with Comparative Example 1, it is seen that even when a polyolefin wax (metallocene wax) was added to a thermoplastic resin (polyolefin), deterioration of physical properties of an injection molded article were not perceived, and the fluidity (flow length) was improved by 5%. This indicates that a mixture of the thermoplastic resin and the polyolefin wax has improved resin flow into the fine parts of the mold, thus it allowing precision molding (molding in the shape precisely conforming to the mold). In addition, by adding a polyolefin wax, releasability from a mold is also improved, and even for thin film molding, adherence of the molded article to the mold can be avoided.

1. A process for producing an injection molded product, comprising injection molding a mixture containing a thermoplastic resin and a polyolefin wax,
wherein the mixture has L/L₀≧1.05, the L being a flow length in the case where the mixture contains the polyolefin wax and the L₀ being a flow length in the case where the mixture contains no polyolefin wax, the L and L₀ being measured under the conditions of a mold temperature of 40° C. and a resin temperature, Tr, as determined by the following equation:
Tr=¾×Tm+100
(wherein Tm represents a melting temperature (° C.) of the thermoplastic resin), using a spiral flow mold having a thickness of 1 mm and a width of 10 mm.

2. The process for producing an injection molded product according to claim 1, wherein the mixture comprises 0.5 to 15 parts by weight of polyolefin wax based on 100 parts by weight of the thermoplastic resin.

3. The process for producing an injection molded product according to claim 2, wherein the polyolefin wax is a polyethylene wax.

4. The process for producing an injection molded product according to claim 3, wherein the thermoplastic resin is polypropylene or polyethylene.

5. An injection molded product obtained by the production method according to claim 4.

6. The process for producing an injection molded product according to claim 1, wherein the polyolefin wax is a polyethylene wax.

7. The process for producing an injection molded product according to claim 6, wherein the thermoplastic resin is polypropylene or polyethylene.

8. The process for producing an injection molded product according to claim 2, wherein the thermoplastic resin is polypropylene or polyethylene.

9. The process for producing an injection molded product according to claim 1, wherein the thermoplastic resin is polypropylene or polyethylene.

10. An injection molded product obtained by the production method according to claim 9.

11. An injection molded product obtained by the production method according to claim 8.

12. An injection molded product obtained by the production method according to claim 7.

13. An injection molded product obtained by the production method according to claim 6.

14. An injection molded product obtained by the production method according to claim 3.

15. An injection molded product obtained by the production method according to claim 2.

16. An injection molded product obtained by the production method according to claim 1.
